(19) United States
(12) Patent Application Publication
(10) Pub. No.: US 2010/0278071 A1
(43) Pub. Date: Nov. 4, 2010

(54) METHOD AND APPARATUS FOR DISCOVERING A DEVICE ON A NETWORK

(76) Inventor: Tomoki HATTORI, Duluth, GA (US)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/432,487

(22) Filed: Apr. 29, 2009

(51) Int. Cl. H04L 12/28

(52) U.S. Cl. 370/254

(57) ABSTRACT

A method for detecting a monitored device on one of a plurality of subnets of a network. The method includes receiving, in a processing server, network database information from a local router on a same subnet as the processing server, the network database information identifying the plurality of subnets of the network. A subnet list is generated based on the received network database information, and stored in a memory. Further, the monitored device is discovered based on a search of the plurality of subnets included in the stored subnet list. The method further includes storing an identification of the discovered monitored device in a monitored device database.

### BACKGROUND OF THE INVENTION

1. Field of the Invention

The present invention relates generally to discovering a device on a network. The present invention is more particularly related to discovering a structure of a network that is divided into a plurality of subnets, and to communicate with devices connected to the plurality of subnets.

2. Description of the Related Art

Large entities, such as a campus or corporation, may have a network including a plurality of different physical networks. Rather than assign each of the different physical networks a different IP network number, the different physical networks can be associated with different subnets. For example, IP addresses can be allocated to the different physical networks using a single IP network number.

One or more different devices may be connected to each of the different subnets. However, in order for a device on a subnet to communicate with devices on a different subnet, the different subnet must be known to that device. For example, a list of the subnets in the network may be previously stored in the device. Alternatively, the subnets may be specified by a user of the device.

Today, device management software is used to communicate with devices on a network. The device management software is typically executed on a computer system and may use the simple network management protocol (SNMP) to monitor status information of the monitored devices. To identify devices to be monitored on the network, the device management software may perform a search for devices connected on the network. However, such a search can only be performed if the network structure is known to the device management software.

For example, since the computer system executing the device management software is assigned an IP address, the device management software can search for devices connected to the same subnet (i.e., a local subnet) as the computer system. However, the device management software cannot search for devices on other subnets of the network without additional information identifying the other subnets.

### SUMMARY OF THE INVENTION

According to an embodiment of the present invention, a method is provided for detecting a monitored device on one of a plurality of subnets of a network. The method includes receiving, in a processing server, network database information from a local router on a same subnet as the processing server, the network database information identifying the plurality of subnets of the network. A subnet list is generated based on the received network database information, and stored in a memory. Further, the monitored device is discovered based on a search of the plurality of subnets included in the stored subnet list. The method further includes storing an identification of the discovered monitored device in a monitored device database.

Further, according to another embodiment of the present invention, there is provided a computer-readable storage medium having instructions embedded therein, which when executed by a processor, cause the processor to perform the method discussed above.

According to another embodiment of the present invention there is provided a processing server configured to connect to a network including a plurality of subnets. The processing server includes means for receiving network database information from a local router on a same subnet as the processing server, the network database information identifying the plurality of subnets of the network; means for generating a subnet list based on the received network database information; means for storing, in a memory, the generated subnet list; means for discovering a monitored device based on a search of the plurality of subnets included in the stored subnet list; and means for storing an identification of the discovered monitored device in a monitored device database.

According to another embodiment of the present invention there is provided a processing server configured to connect to a network including a plurality of subnets. The processing server has a processor that includes an acquisition unit configured to receive network database information from a local router on a same subnet as the processing server, the network database information identifying the plurality of subnets of the network; a subnet list generation unit configured to generate a subnet list based on the received network database information; a first storage unit configured to store, in a memory, the generated subnet list; a discovery unit configured to discover a monitored device based on a search of the plurality of subnets included in the stored subnet list; and a second storage unit configured to store an identification of the discovered monitored device in a monitored device database.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates an exemplary network structure including a plurality of devices connected to a plurality of subnets on a network;

FIG. 2a illustrates the hardware components of the server illustrated in FIG. 1;

FIG. 2b illustrates the electronic components of the server of FIG. 1;

FIG. 3a illustrates the hardware components of a digital copier/printer multi-function machine;

FIG. 3b illustrates the electronic components of the digital copier/printer multi-function machine illustrated in FIG. 3a;

FIG. 3c illustrates details of the multi-port communication interface illustrated in FIG. 3b;

FIG. 4 illustrates the electronic components of a router;

FIG. 5 provides a flow diagram of the subnet and device discovery process in an embodiment of the present invention;

FIG. 6 illustrates a flow diagram of the device discovery of FIG. 5 in further detail;

FIG. 7 illustrates a subnet discovery process using the open shortest path first (OSPF) routing protocol;

FIG. 8a illustrates a device discovery process when a network device address table is available for a subnet;

FIG. 8b illustrates a device discovery process when the network device address table is not available for the subnet;

FIG. 9 illustrates an update process for updating a device search location subnet list;

FIG. 10 illustrates an OSPF Hello protocol state diagram;

FIG. 11 illustrates an OSPF database exchange state diagram;

FIG. 12 illustrates a process for establishing adjacency between routers using OSPF;

FIG. 13 illustrates a subnet discovery flow diagram of an embodiment of the present invention using OSPF;

FIG. 14 illustrates a device discovery flow diagram of an embodiment of the present invention using the simple network management protocol (SNMP); and

FIGS. 15a and 15b illustrate exemplary update flow diagrams of the present invention using OSPF.

### DETAILED DESCRIPTION OF THE PREFERRED EMBODIMENTS

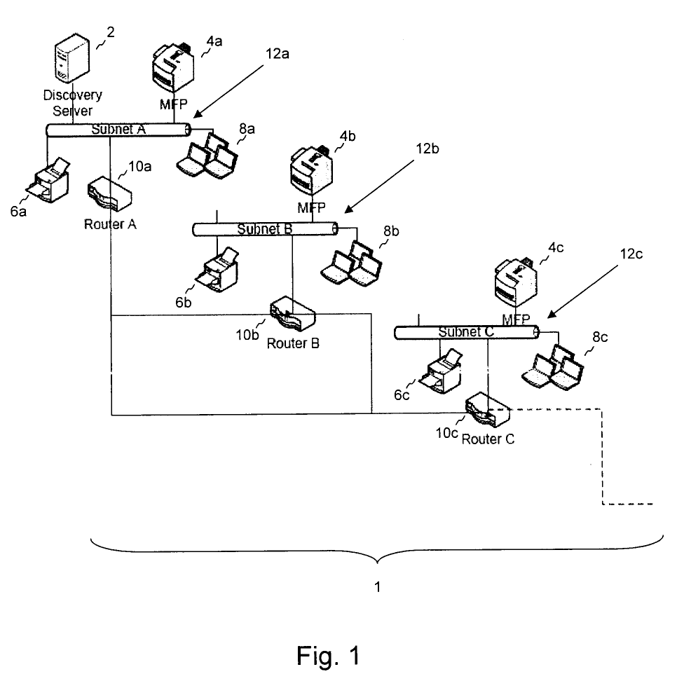

Referring now to the drawings, wherein like reference numerals designate identical or corresponding parts throughout the several views, FIG. 1 shows a network 1, such as a Local Area Network (LAN), Wide Area Network (WAN), or Wireless Local Area Network (WLAN), including subnet 12a, subnet 12b, and subnet 12c. The subnets 12a-12c are connected to the network 1 via routers 10a-10c, respectively. A server 2 is connected to the subnet 12a (the local subnet).

As illustrated in FIG. 1, a digital copier/printer multi-function machine (MFP) 4a, a computer 8a, and a printer 6a are connected to the subnet 12a. An MFP 4b, a computer 8b, and a printer 6b are connected to the subnet 12b. Further, an MFP 4c, a computer 8c, and a printer 6c are connected to the subnet 12c. The server 2 is configured to discover and to communicate with one or more devices (monitored devices) connected to the network 1. For example, the server 2 may be configured to monitor or manage the MFPs 4 and printers 6 connected to the network. In such an example, the MFPs 4 and printers 6 correspond to the monitored devices connected to the network 1.

It should be noted that the network 1 is not limited to the network structure illustrated in FIG. 1. The network 1 may be divided into any number of different subnets. Further, each of the subnets may include any number of connected devices of one or more different types.

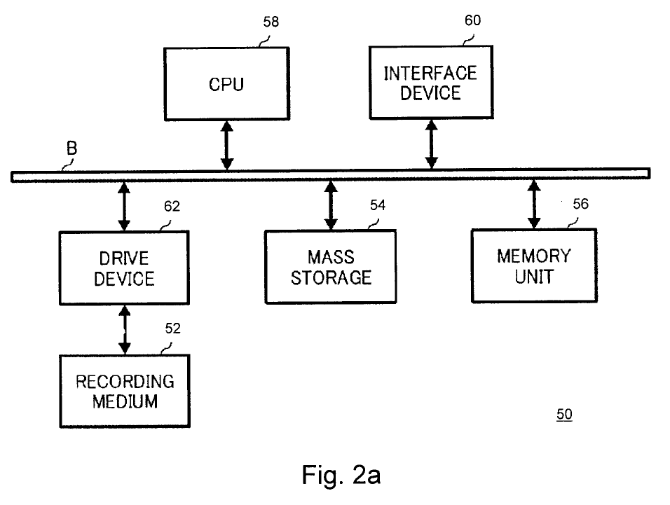

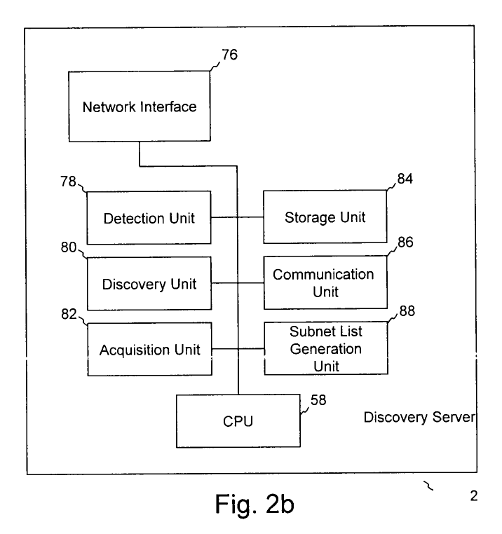

FIG. 2a illustrates a computer system 50 upon which an embodiment of the server 2 may be implemented. The computer system 50 includes a bus B or other communication mechanism for communicating information such as address information and data, and a processor/CPU 58 coupled with the bus B for processing the information. The computer system 50 also includes a main memory/memory unit 56, such as a random access memory (RAM) or other dynamic storage device (e.g., dynamic RAM (DRAM), static RAM (SRAM), and synchronous DRAM (SDRAM)), coupled to the bus B for storing information and instructions to be executed by processor/CPU 58. In addition, the memory unit 56 may be used for storing temporary variables or other intermediate information during the execution of instructions by the CPU 58. The computer system 50 may also further include a read only memory (ROM) or other static storage device (e.g., programmable ROM (PROM), erasable PROM (EPROM), and electrically erasable PROM (EEPROM)) coupled to the bus B for storing static information and instructions for the CPU 58.

The computer system 50 may also include a disk controller coupled to the bus B to control one or more storage devices for storing information and instructions, such as mass storage 54 which may be a hard disk drive, for example, and drive device 62 (e.g., floppy disk drive, read-only compact disc drive, read/write compact disc drive, compact disc jukebox, tape drive, flash memory or a flash memory based drive, and removable magneto-optical drive). The storage devices may be added to the computer system 50 using an appropriate device interface (e.g., small computer system interface (SCSI), integrated device electronics (IDE), enhanced-IDE (E-IDE), direct memory access (DMA), or ultra-DMA).

The computer system 50 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)) in order to carry out the desired functionality.

The computer system 50 may also include a display controller coupled to the bus B to control a display, such as a cathode ray tube (CRT), organic light emitting diode (OLED) display, or liquid crystal display (LCD), for displaying information to a computer user. The computer system may include input devices, such as a keyboard and a pointing device, for interacting with a computer user and providing information to the processor. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system 50 performs a portion or all of the processing steps in response to the CPU 58 executing one or more sequences of one or more instructions contained in a memory, such as the memory unit 56. Such instructions may be read into the memory unit from another computer-readable medium, such as the mass storage 54 or a removable media 52. One or more processors in a multi-processing arrangement may also be employed to execute the sequences of instructions contained in memory unit 56. In alternative embodiments, hard-wired circuitry may be used in place of or in combination with software instructions. Thus, embodiments are not limited to any specific combination of hardware circuitry and software.

As stated above, the computer system 50 includes at least one computer-readable medium 52 or memory for holding instructions programmed according to the teachings described herein and for containing data structures, tables, records, or other data described herein. Examples of computer-readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other storage medium from which a computer can read.

Stored on any one or on a combination of computer-readable media is software for controlling the computer system 50, for driving a device or devices, and for enabling the computer system 50 to interact with a human user. Such software may include, but is not limited to, device drivers, operating systems, development tools, and applications software. Such computer-readable media further includes the computer program product for performing all or a portion (if processing is distributed) of the processing described herein.

The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The term “computer-readable medium” as used herein refers to any medium that participates in providing instructions to the CPU 58 for execution. A computer-readable medium may take many forms, including but not limited to, non-volatile media, and volatile media. Non-volatile media includes, for example, optical, magnetic disks, and magneto-optical disks, such as the mass storage 54 or the removable media 52. Volatile media includes dynamic memory, such as the memory unit 56.

Various forms of computer-readable media may be involved in carrying out one or more sequences of one or more instructions to the CPU 58 for execution. For example, the instructions may initially be carried on a magnetic disk of a remote computer. The remote computer can load the instructions remotely into a dynamic memory and send the instructions over a telephone line using a modem. A modem local to the computer system 50 may receive the data on the telephone line and use an infrared transmitter to convert the data to an infrared signal. An infrared detector coupled to the bus B can receive the data carried in the infrared signal and place the data on the bus B. The bus B carries the data to the memory unit 56, from which the CPU 58 retrieves and executes the instructions. The instructions received by the memory unit 56 may optionally be stored on mass storage 54 either before or after execution by the CPU 58.

The computer system 50 also includes a communication interface 60 coupled to the bus B. The communication interface 58 provides a two-way data communication coupling to a network that is connected to, for example, a local area network (LAN), or to another communications network such as the Internet. For example, the communication interface 60 may be a network interface card to attach to any packet switched LAN. As another example, the communication interface 60 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 60 sends and receives electrical, electromagnetic, or optical signals that carry digital data streams representing various types of information.

The network typically provides data communication through one or more networks to other data devices. For example, the network may provide a connection to another computer through a local network (e.g., a LAN) or through equipment operated by a service provider, which provides communication services through a communications network. The local network and the communications network use, for example, electrical, electromagnetic, or optical signals that carry digital data streams, and the associated physical layer (e.g., CAT 5 cable, CAT 6 cable, coaxial cable, optical fiber, etc). The signals through the various networks and the signals on the network and through the communication interface 60, which carry the digital data to and from the computer system 50 may be implemented in baseband signals, or carrier wave based signals. The baseband signals convey the digital data as un-modulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as un-modulated baseband data through a “wired” communication channel and/or sent within a predetermined frequency band, different than baseband, by modulating a carrier wave. The computer system 50 can transmit and receive data, including program code, through the network and the communication interface 60. Moreover, the network may provide a connection to a mobile device such as a personal digital assistant (PDA) laptop computer, or cellular telephone.

FIG. 2b illustrates electronic components of the server 2 in a first embodiment. The server 2 is connected to the network 1 via a network interface 76. The network interface 76 may be implemented by a chip integrated on a motherboard, a network interface card, or any other circuitry configured to allow the server 2 to communicate over the network 1. The network interface 76 may connect to the network 1 via wires or wirelessly. The server 2 further includes a detection unit 78, a discovery unit 80, an acquisition unit 82, a storage unit 84, a communication unit 86, a subnet list generation unit 88, and the CPU 58. The detection unit 78, discovery unit 80, the acquisition unit 82, the communication unit 86, and the subnet list generation unit 88 may be implemented in one or more software components executed by the CPU 58. Alternatively, one or more processors in a multi-processing arrangement may also be employed to execute instructions for the one or more software components, with the CPU 58 acting as a system controller. In alternative embodiments, hard-wired circuitry may be used in place of or in combination with software instructions. Thus, embodiments are not limited to any specific combination of hardware circuitry and software. The storage unit 84 may be any type of memory including the computer-readable media described above.

In the server 2, the detection unit 78 detects a router located on the same subnet as the server 2. The acquisition unit 82 receives network database information, which includes information regarding the subnets of the network 1, from the detected router. The subnet list generation unit 88 generates a device search location subnet list (subnet list) based on the network database information. The storage unit 84 stores the generated the generated subnet list. The discovery unit 80 discovers devices connected to one or more of the subnets in the subnet list. The storage unit 84 further stores an identification of the discovered devices. The communication unit 86 communicates with the discovered devices.

The above details have been described with respect to a server, but the present embodiment is equally applicable to other computer devices such as a computer terminal (e.g., a personal computer) or a mobile terminal (e.g., a cellular phone, personal digital assistant, etc.).

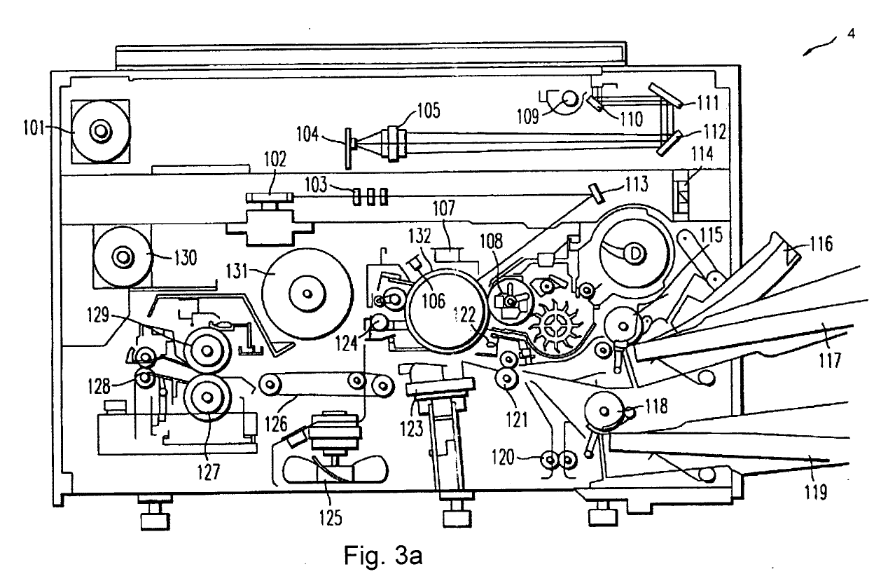

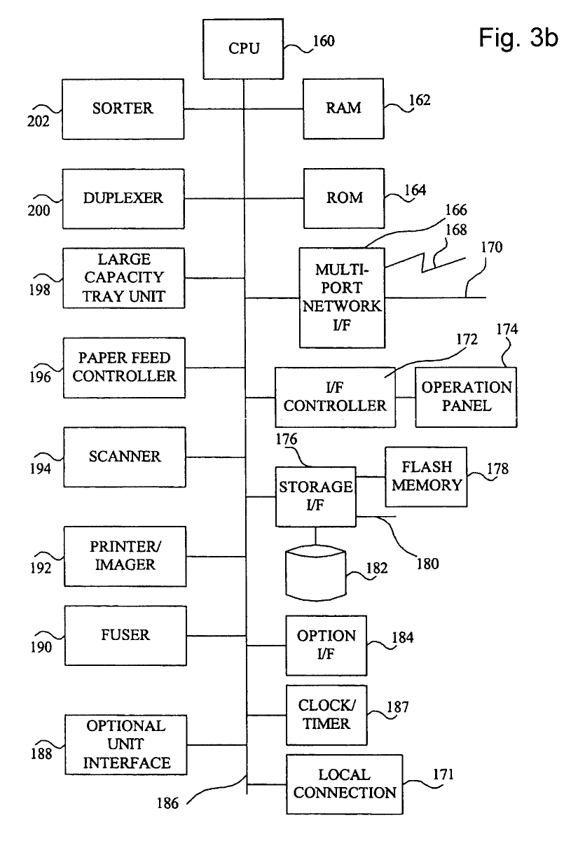

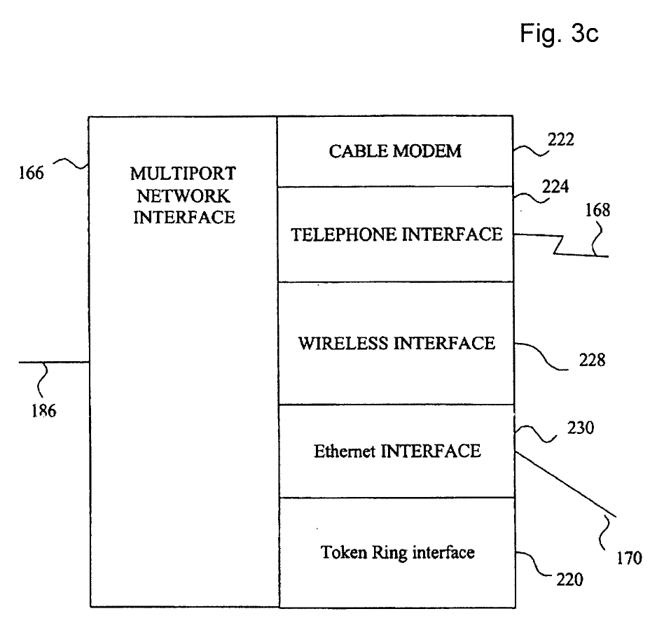

FIG. 3a illustrates an exemplary mechanical layout of the MFP 4 illustrated in FIG. 1. In FIG. 3a, 101 is a fan for the scanner, 102 is a polygon mirror used with a laser printer, and 103 designates an F theta lens used to collimate light from a laser. Reference number 104 designates a sensor for detecting light from the scanner, 105 is a lens for focusing light from the scanner onto the sensor 104 and 106 is a quenching lamp used to erase images on the photoconductive drum 132. There is a charging corona unit 107 and a developer roller 108. Reference numeral 109 designates a lamp used to illustrate a document to be scanned and 110, 111, and 112 designate mirrors used to reflect light onto the sensor 104. There is a drum mirror 113 used to reflect light to the photoconductive drum 132 originating from the polygon mirror 102. Reference numeral 114 designates a fan used to cool the charging area of the digital copier/printer multi-function machine, and 115 is a first paper feed roller used for feeding paper from the first paper cassette 117, and 116 is a manual feed table. Similarly, element 118 is a second paper feed roller for the second cassette 119. Reference numeral 120 designates a relay roller, 121 is a registration roller, 122 is an image density sensor, and 123 is a transfer/separation corona unit. Reference numeral 124 is a cleaning unit, 125 is a vacuum fan, element 126 is a transport belt, 127 is a pressure roller, and 128 is an exit roller. Reference numeral 129 is a hot roller used to fix toner onto the paper, 130 is an exhaust fan, and 131 is the main motor used to drive the digital copier/printer multi-function machine.

FIG. 3b illustrates a block diagram of the electronic components of the MFP 4 illustrated in FIG. 3a. The CPU 160 is a microprocessor and acts as the system controller. There is a random access memory (RAM) 162 to store dynamically changing information including operating parameters of the digital copiers. A read-only memory (ROM) 164 stores the program code used to run the MFP 4 and also information describing the static-state data such as model number, serial number, and default parameters that would not change over the life of the machine. When the device needs to boot up from either a hard disk or flash memory, the ROM memory 164 stores the boot sequence.

There is provided a multi-port communication interface 166, which allows the MFP 4 to communicate with external devices. Reference numeral 168 represents a telephone or other communication line including a wireless channel. Further information of the multi-port communication interface is described with respect to FIG. 3c. An interface controller 172 is used to connect an operation panel 174 to a system bus 186. The operation panel 174 includes standard input and output devices found on a digital copier/printer multi-function machine or business office appliance including some function buttons such as reduce/enlarge and numeric buttons, etc. Additionally, a liquid crystal display may be included within the operation panel 174 to display parameters and messages of the apparatus. The operation panel also can be a touch panel in which the display and function buttons may change according to the context.

A local connection interface 171 is a connection through local port such as RS232, USB and IEEE 1394. This interface 171 allows external devices to be attached to the apparatus.

A storage interface 176 connects storage devices to the system bus 186. The storage devise include a flash memory 178 and a disk 182. There is a connection 180 connected to the storage interface 176 which allows for additional memory devices to be connected. The flash memory 178 is used to store semi-static data which describes parameters of the device which infrequently change over the life of the apparatus, including the option configuration, network access parameters, and work group, and also can be used to store dynamic data that describes parameters dynamically changing such as print count. An option interface 184 allows additional option devices to be attached and controlled. A clock/timer 187 is utilized to keep track of both the time and date and also to measure elapsed time.

On the left side of FIG. 3b, the various sections making up the MFP 4 are illustrated. Reference numeral 202 designates a sorter and contains sensors and actuators used to sort the output of the digital copier/printer multi-function machine. There is a duplex 200 that allows a duplex operation to be performed and includes conventional sensors and actuators. The MFP 4 includes a large capacity tray unit 198 that allows paper trays holding a large number of sheets to be used. The large capacity tray unit 198 includes conventional sensors and actuators.

A paper feed controller 196 is used to control the operation of feeding paper into and through the MFP 4. A scanner 194 is used to scan images into the MFP 4 and includes a control system of conventional scanning elements such as a light, mirror, etc. Additionally, scanner sensors are used, such as a home position sensor, to determine that the scanner is in the home position, and a lamp thermistor is used to ensure proper operation of the scanning lamp. There is a printer/imager 192, which prints the output of the MFP 4 and includes a conventional laser printing mechanism, a toner sensor, and an image density sensor. The fuser 190 is used to fuse the toner onto the page using a high temperature roller and includes an exit sensor, a thermistor to assure that the fuser 190 is not over heating, and an oil sensor. Additionally, there is an optional unit interface 188 used to connect optional units such as an automatic document feeder, a different type of sorter/collator, or other elements that can be added to the MFP 4.

FIG. 3c illustrates details of the multi-port network interface 166. The MFP 4 may communicate to external devices through a Token Rink interface 220, a cable modem unit 222 that has a high speed connection over cable, a conventional telephone interface 224 that connects to a telephone line 168, wireless interface 228, and an Ethernet interface 230. Other interfaces (not shown) include, but are not limited to, a Digital Subscriber line. The multi-port network interface does not need to have all the interfaces described in FIG. 3c.

The CPU or other microprocessor or circuitry executes a monitoring process to monitor the state of each of the sensors of the MFP 4, and a sequencing process is used to execute the instructions of the code used to control and operate the MFP 4. Additionally, there is (1) a central system control process executed to control the overall operation of the MFP 4 and (2) a communication process used to assure reliable communication to external devices connected to the MFP 4. The system control process monitors and controls data storage in a static state (e.g., the ROM 164 of FIG. 3b), a semi-static state (e.g., the flash memory or disk 182), or a dynamic state (e.g., a volatile or non-volatile memory, the RAM 162 or the flash memory 178 or disk 182).

The above details have been described with respect to a digital copier/printer multi-function machine, but this embodiment is equally applicable to other business office machines or devices such as an analog copier, a facsimile machine, a scanner, a printer, a facsimile server, or other business office machines and business office appliance such as a router, firewall and small office router/firewall, or appliances (e.g., a microwave oven, digital camera, cellular phone, refrigerator, washer, dryer, visual audio system, DVD system and so on). Additionally, the present embodiment includes other types of devices that operate using store-and-forward or direct connection-based communication. Such devices include metering systems (including gas, water, or electricity metering systems), parking meters, vending machines, or any mechanical devices (e.g., automobiles) that need to be monitored and serviced during operation.

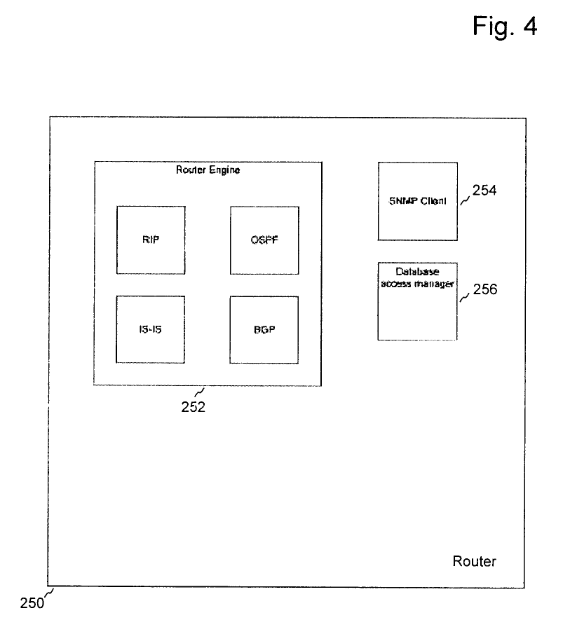

FIG. 4 illustrates the electronic components of the router 10 in an embodiment of the present invention. The router 10 includes a router engine 252 containing one or more routing protocols. The routing engine 252 may include software and/or hardware for implementing the routing information protocol (RIP), intermediate system to intermediate system (IS-IS) protocol, open shortest path first (OSPF) routing protocol, and border gateway protocol (BGP). However, the routing engine 252 is not so limited, and may include any one or more of the RIP, IS-IS-OSPF, and BGP routing protocols, or any routing protocol used to communicate over a network. The router 250 further includes a database access manager 256 that stores the subnet information of the network, and may optionally include a simple network management (SNMP) client 254 that communicates with the monitored devices. The router engine 252 and SNMP client 254 may be implemented by one or more software components executed by a processor. In alternative embodiments, hard-wired circuitry may be used in place of or in combination with software instructions. Exemplary commercially available routers which may be used with the invention include but are not limited to the CISCO™ 7000 series (Enterprise) routers, Cisco 800 series (Small office, home office) routers, etc.

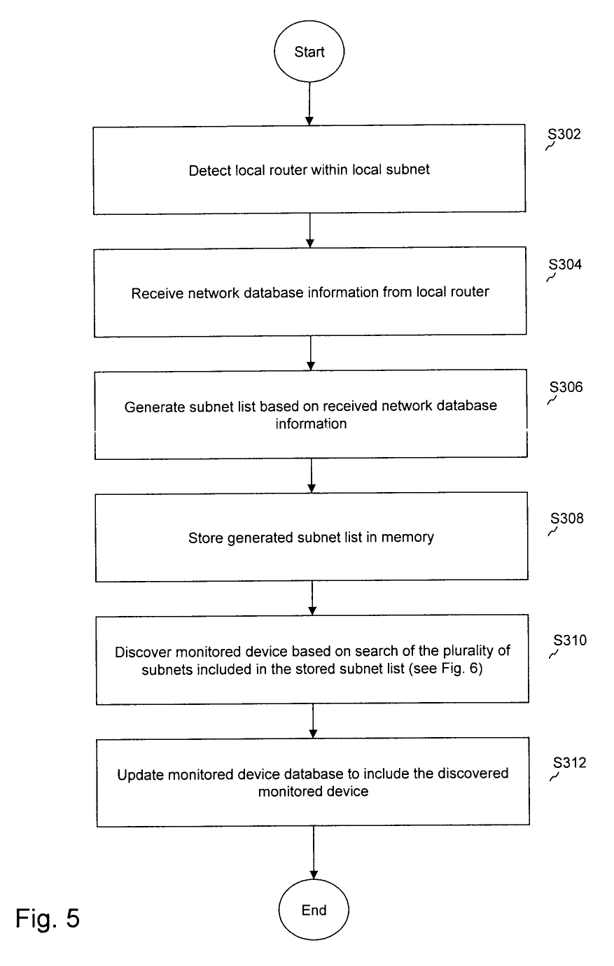

FIG. 5 provides an overview of a process for discovering devices connected to the network 1. When the server 2 is first connected to the network 1, the server 2 initiates detection of a local router (e.g., the router 10a of FIG. 1) within a same subnet (the local subnet) as the server 2 in step S302. After the local router has been detected, the server 2 receives network database information from the local router in step S304. The server 2 generates a subnet list based on the received network database information in step S306. After the subnet list is generated, the server 2 stores the subnet list in memory in step S308. Further, in step S310, the server 2 discovers devices to be monitored on the network 1 based on a search of a plurality of subnets included in the subnet list stored in step S308. In step S312, a monitored device database, including a list of the devices to be monitored on the network 1, is updated to include the devices discovered in step S310.

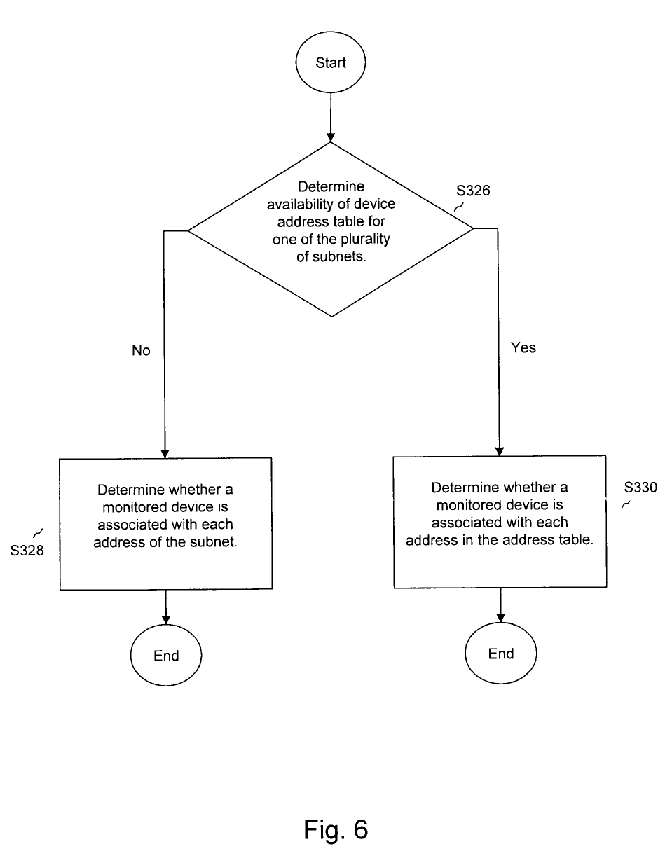

FIG. 6 illustrates the monitored device discovery step S310 of FIG. 5, in further detail. As illustrated in FIG. 6, the server 2 determines whether a device address table is available for one of the plurality of subnets included in the subnet list in step S326. In an embodiment of the present invention, the server 2 determines whether the device address table is available from a router associated with the respective subnet. If the device address table is determined to be unavailable, the server 2 determines whether a monitored device (i.e., a device of a predetermined type) is associated with each possible network address of the subnet in step S328. However, if the device address table is determined to be available, the server 2 determines whether a monitored device (i.e., a device of a predetermined type) is associated with each address in the address table in step S330. Accordingly, when the device address table is available for the subnet, the server 2 searches only the addresses within the device address table that are known to have an associated device, rather than search each possible address of the subnet, so as to more efficiently identify whether a monitored device is located on the subnet. This process of FIG. 6 is repeated for each of the plurality of subnets included in the subnet list.

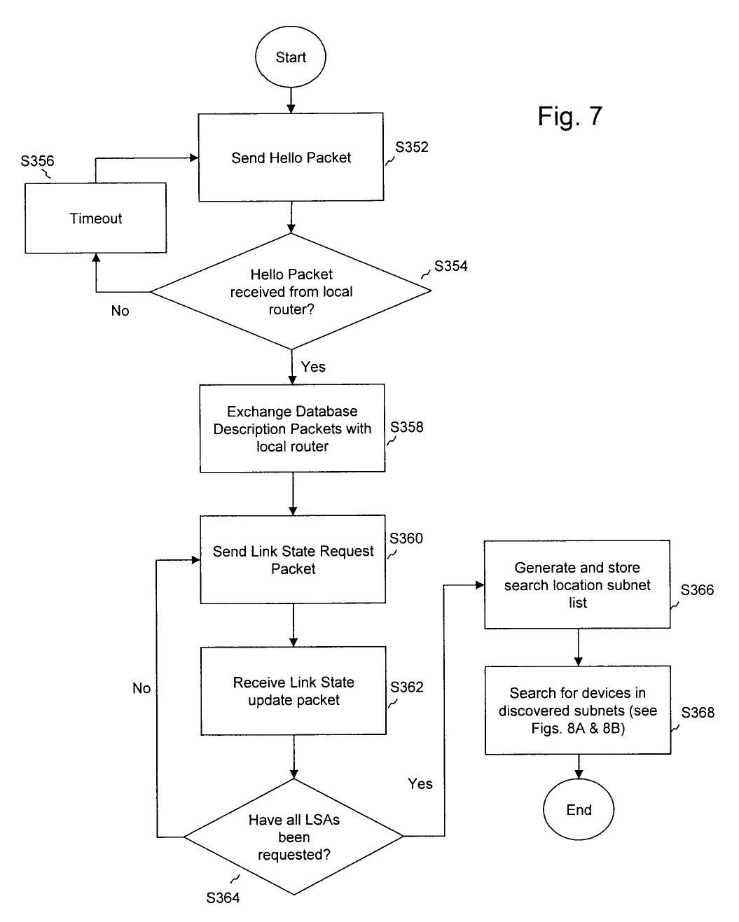

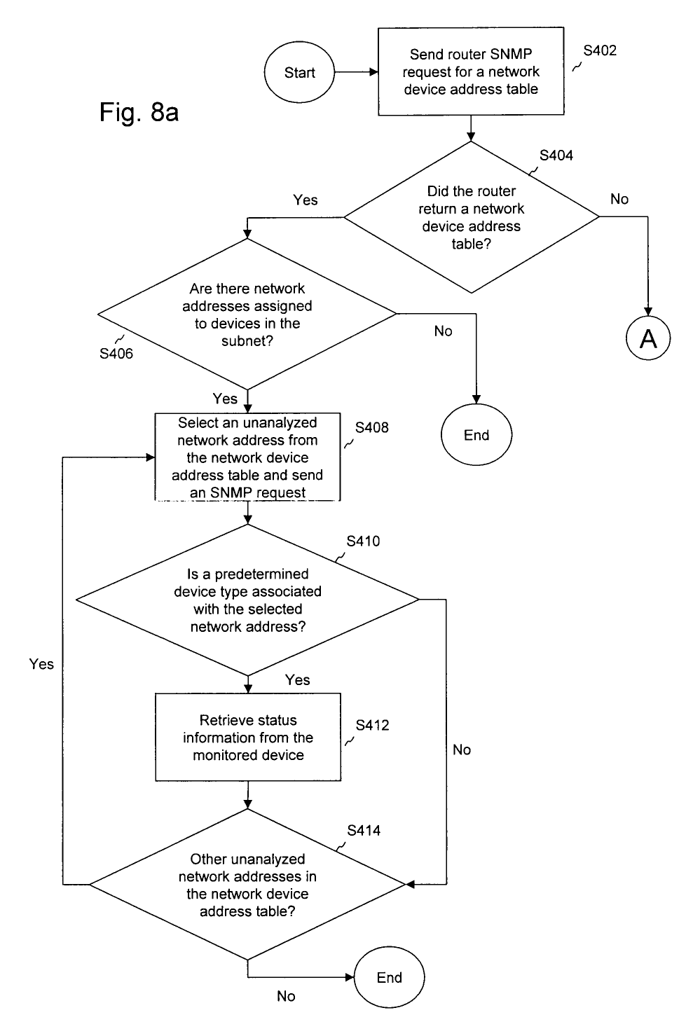

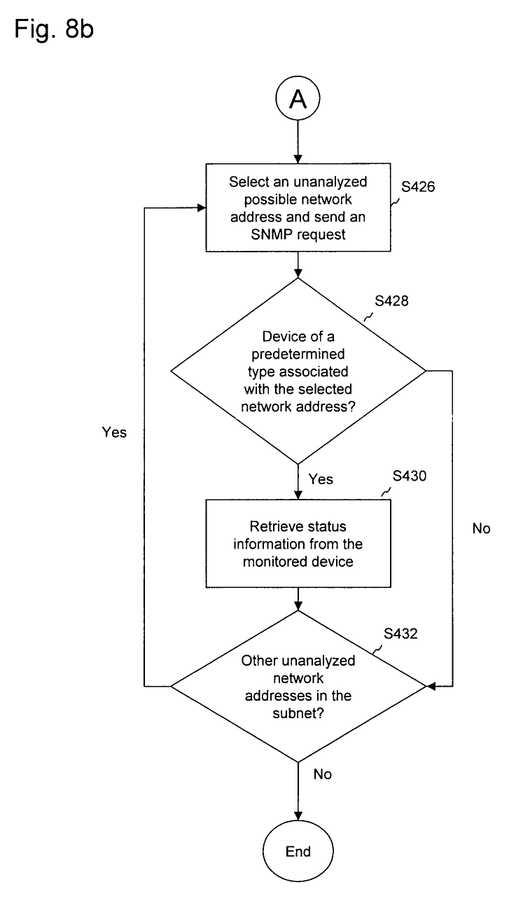

FIG. 7 illustrates a process for discovering devices to be monitored on a plurality of different subnets in a network using the Open Shortest Path First (OSPF) routing protocol. OSPF is a widely used protocol to carry link state information for IP routing purposes, and is described in J. Moy, “OSPF Version 2”, RFC 2328, April 1998, which is incorporated herein by reference in its entirety. When the server 2 is connected to the network 1, the server 2 sends a Hello packet within the subnet 12a, in step S352. In step S354, the server 2 determines whether a Hello packet is received from a local router in step S354. If the server 2 does not receive the Hello packet from the local router within a predetermined period of time, a timeout occurs (step S356), and the process returns to step S352 in which the server 2 sends the Hello packet within the subnet 12a. When the server 2 determines that the Hello packet has been received from the local router in step S354, the server exchanges database description packets with the local router in step S358. Based on the database description packets received from the local router in step S358, the server 2 sends a link state request packet to the local router in step S360. In response, the server 2 receives a link state update packet from the local router in step 362. In step S364, the server 2 determines whether all link state advertisements (LSAs), identified in the database description packets have been requested. The server 2 repeats steps S360 and S362 until all the LSAs have been requested. After all the LSAs have been requested, the server 2 generates and stores a search location subnet list based on the link state information received from the local router, in step S366. In step S368, the server 2 performs a search for devices in the subnets included in the search location subnet list, as further discussed with respect to FIGS. 8 and 8b.

Note that while FIG. 7 illustrates that the server 2 waits until a complete set of Database Description packets has been received from the local before transmitting link state request packets, and all LSAs have been requested before generating and storing the search location subnet list, this need not be the case. The server 2 could send the Link State Request packets while receiving the Database Description packets by, for example, interleaving the sending of Link State Request packets within the reception of the database description packets. Further, the server 2 may generate and/or update the search location subnet list while the link state advertisements are received from the local router.

A process for identifying the devices to be monitored and retrieving information from the monitored devices is illustrated in FIGS. 8a and 8b using the simple network management protocol (SNMP). As illustrated in FIG. 8a, the server 2 sends a SNMP request for a network device address table to a router of one of the plurality of subnets 12a-12c in step S402. However, other communication protocols may be used to request the network device address table, such as HTTP, FTP, or Simple Object Access Protocol (SOAP). The network device address table identifies each device connected to the subnet of the router and its corresponding network address, e.g., an IP address, MAC address, or any other address that uniquely identifies the device in the subnet. In step S404, the server 2 determines whether the network device address table was returned from the router. If the server 2 determines that the network device address table was returned from the router, the server 2 determines whether the network device address table includes a network address assigned to a device in the subnet, in step S406. The process ends if the network device address table does not include any assigned network addresses. If the server 2 determines that the network device address table includes at least one network address associated with a device, the server 2 selects an unanalyzed network address from the network device address table and sends an SNMP request to identify the device type in step S408. The server 2 determines whether the device associated with the selected unanalyzed network address is of a predetermined type in step S410. When the device associated with the selected unanalyzed network address is of the predetermined type, status information is retrieved from the device in step S412 and the process proceeds to step S414 in which the server 2 determines whether there are any other unanalyzed network addresses in the device address table. When the device associated with the selected unanalyzed type is not of the predetermined type, the process proceeds to step S414. Steps S408-S412 are repeated for each unanalyzed network address in the network device address table.

FIG. 8b illustrates a device discovery and status information retrieval process when the server 2 determines that the router did not return the network device address table. In step S426, the server 2 selects an unanalyzed network address from a set of possible network addresses within the subnet, and sends an SNMP request to the unanalyzed network address. In step S428, the server 2 determines whether the device of a predetermined type is associated with the selected unanalyzed network address. When the device associated with the selected unanalyzed network address is of the predetermined type, status information is retrieved from the device in step S430 and the process proceeds to step S432, in which the server 2 determines whether there are any other unanalyzed network addresses in the set of possible network addresses within the subnet. When the device associated with the selected unanalyzed type is not of the predetermined type, the process directly proceeds to S432. The server 2 repeats steps S426-S430 for each unanalyzed network address in the set of possible network addresses within the subnet.

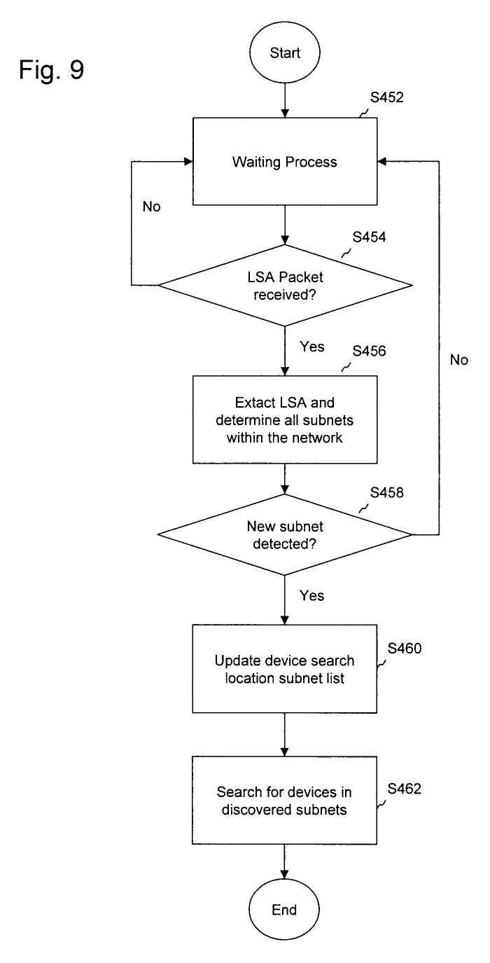

FIG. 9 illustrates an update process for the server 2. In step S452, the server 2 waits to receive updated information regarding the network. When the updated network information (e.g., a link state advertisement packet) is received in step S454, information regarding subnets within the network 1 are extracted in step S456. Based on the extracted subnet information, a determination is made as to whether a new subnet has been detected in step S458. The determination of the new subnet may be based on a comparison between the extracted subnet information and the subnet list stored in the server 2. If the new subnet is not detected, the process returns to step S452 and the server again waits to receive the updated information regarding the network. If the new subnet is detected in step S458, the device search location subnet list is updated with the newly detected subnet, and a search is performed for devices to be monitored in the newly detected subnet in step S462.

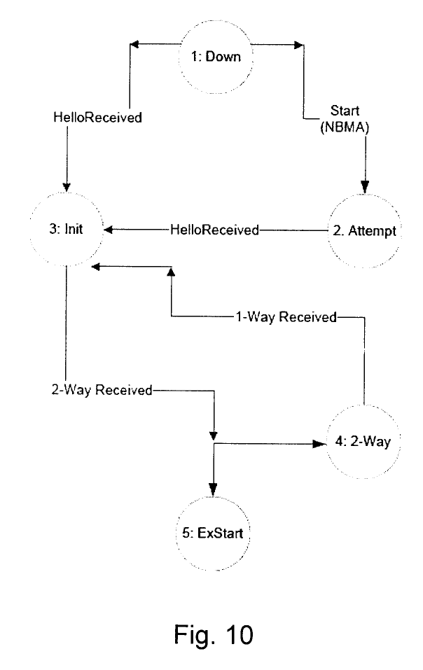

FIG. 10 illustrates an OSPF Hello Protocol State diagram. The Hello protocol is responsible for establishing and maintaining neighboring relationships, and also ensures that communication between neighbors is bi-directional. Hello packets are sent periodically out of all router interfaces. Bi-directional communication is indicated when the router sees itself listed in a neighbor's Hello packet. On broadcast and non-broadcast multiple access (NBMA) networks, the Hello protocol elects a Designated Router (DR) for the network.

The Hello protocol works differently on broadcast networks, NBMA networks, and point-to-multipoint networks. On broadcast networks, each router advertises itself by periodically multicasting Hello packets. This allows neighbors to be discovered dynamically. These Hello packets contain the router's view of the Designated Router's identity, and the list of routers whose Hello packets have been seen recently.

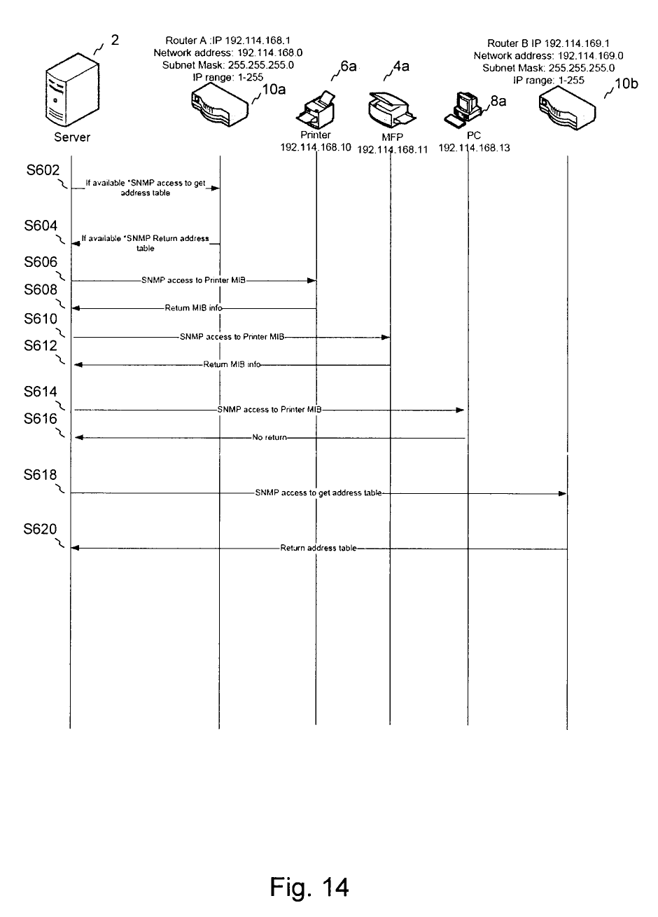

The states of the OSPF Hello Protocol State Diagram illustrated in FIG. 14 are as follows:
“1: Down”—the connection of the router is down;
“2: Attempt”—the router is sending Hello protocol packets;
“3: Init”—Hello packets are exchanged between routers to create a Neighbor Relationship;
“4: 2-Way”—the routers add each other to their Neighbor database and they become neighbors; and
“5: ExStart”—the Designated Router (DR) and Backup Designated Router (BDR) create an adjacency with each other and they begin creating their link-state databases using Database Description packets.

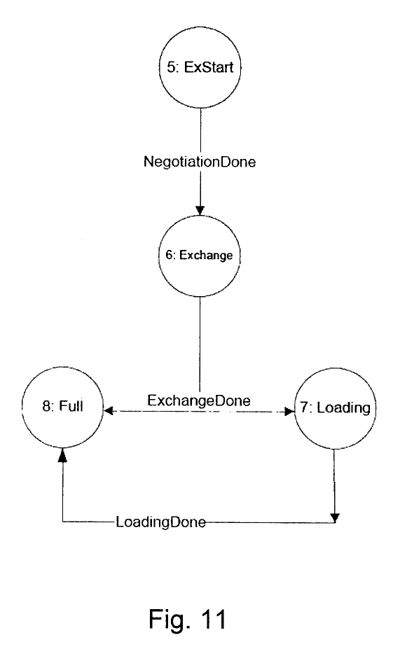

After a neighbor has been discovered, bi-directional communication ensured, and (if on a broadcast or NBMA network) the Designated Router elected, a decision is made regarding whether or not an adjacency should be formed with the neighbor. If an adjacency is formed, the first step is to synchronize the neighbors' link-state databases as further illustrated in the OSPF Data Exchange State of FIG. 11.

FIG. 11 illustrates an OSPF Database Exchange State diagram. In a link-state routing algorithm, it is important for all routers' link-state databases to stay synchronized. OSPF simplifies this by requiring only adjacent routers to remain synchronized. The synchronization process begins as soon as the routers attempt to bring up the adjacency. Each router describes its database by sending a sequence of database description packets to its neighbor. Each database description packet describes a set of LSAs belonging to the router's database. When the neighbor sees an LSA that is more recent than its own database copy, it makes a note that this newer LSA should be requested.

The sending and receiving of database description packets is called the “Database Exchange Process.” During this process, the two routers form a master/slave relationship. Each database description packet has a sequence number. Database description packets sent by the master (polls) are acknowledged by the slave through echoing of the sequence number. Both polls and their responses contain summaries of link state data. The master is the only one allowed to retransmit database description packets. It does so only at fixed intervals, the length of which is the configured per-interface constant RxmtInterval.

Each database description contains an indication that there are more packets to follow—the M-bit (The More bit), which indicates that more database description packets follow when set to 1. The database exchange process is over when a router has received and sent database description packets with the M-bit off.

The states of the OSPF Database Exchange State Diagram illustrated in FIG. 11 are as follows:
“5: ExStart”—the DR and BDR create an adjacency with each other and they begin creating their link-state databases using Database Description Packets;
“6: Exchange”—discovering routes by exchanging Database Description Packets;
“7: Loading”—receiving information from the neighbor; and
“8: Full”—the link-state databases are completely synchronized, and the routers are routing traffic and continue sending each other Hello packets to maintain the adjacency and the routing information.

During and after the database exchange process, each router has a list of those LSAs for which the neighbor has more up-to-date instances. These LSAs are requested in link state request packets. Link state request packets that are not satisfied are retransmitted at fixed intervals of time RxmitInterval. When the database description process has completed and all link state requests have been satisfied, the databases are deemed synchronized and the routers are marked fully adjacent. At this time the adjacency is fully functional and is advertised in the two routers' LSAs.

The adjacency is used by a flooding procedure, as soon as the database exchange process begins. This simplifies database synchronization, and guarantees that it finishes in a predictable period of time. In the flooding procedure, LSAs are sent to all routers within the network. For example, a router may send out LSAs to each one of its neighbors. In response, each LSA is copied by the neighbors, which forward the LSAs to each one of their neighbors, respectively, except the router that sent the LSA. This process may be repeated until the LSAs are transmitted to each of the routers within the network.

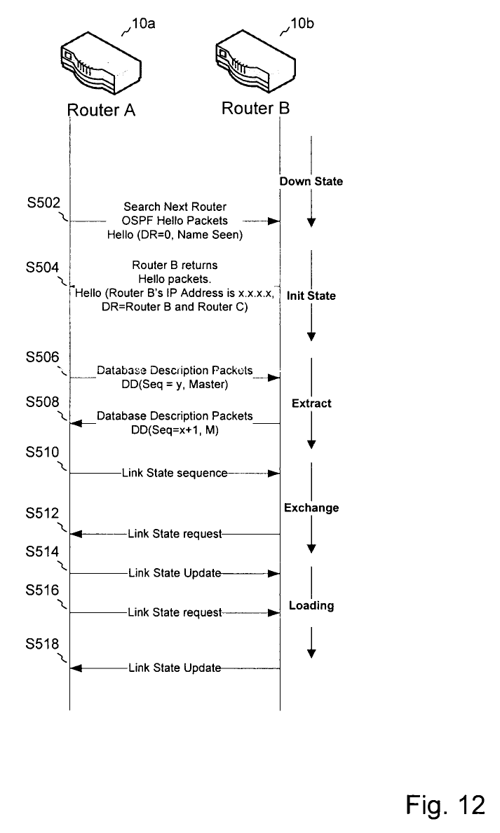

FIG. 12 illustrates an example of adjacency forming between two routers 10a and 10b on the network. The routers 10a and 10b are both connected to a broadcast network. It is assumed that router 10b is the Designated Router for the network, and that router 10b has a higher Router ID than router 10a. The neighbor state changes realized by each router are listed on the sides of FIG. 12.

Initially, an interface of the router 10a to the network becomes operational. The router 10a begins sending Hello Packets in step S502, although it does not know the identity of the Designated Router or of any other neighboring routers. The router 10b hears this Hello (moving the router 10b to the Init State), and in its next Hello Packet indicates that it is itself the Designated Router and that it has heard Hello Packets from the router 10a in step S504. This in turn causes the router 10a to go to the ExStart state, as it starts to bring up the adjacency.

The router 10a begins by asserting itself as the master. When the router 10a sees that router 10b is the master (because of B's higher Router ID), the router 10a transitions to a slave state and adopts the router 10b's DD sequence number. Database description packets are then exchanged, with polls coming from the master (router 10b) and responses from the slave (router 10a). The sequence of database description packets ends when both the poll and associated response has the M-bit off. In this example, it is assumed that the router 10b has a completely up to date database. In that case, the router 10b goes immediately into the Full state. The router 10a will go into the Full state after updating the necessary parts of its database. This is done by sending Link State Request packets, and receiving Link State Update Packets in response. Note that while FIG. 12 illustrates that the router 10a waits until a complete set of Database Description packets has been received from router 10b, this need not be the case. The router 10a could send the Link State Request packets while receiving the Database Description packets by, for example, interleaving the sending of Link State Request packets within the reception of the database description packets.

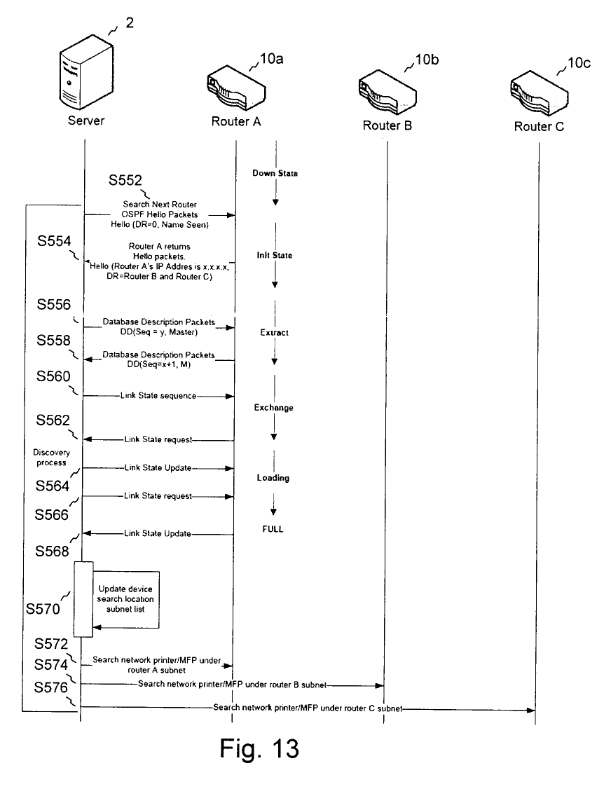

FIG. 13 illustrates the discovery flow process between the server 2 and the router 10a (the local router as illustrated in FIG. 1) in accordance with the OSPF routing protocol. The server 2 emulates a router and communicates with the router 10a in substantially the same manner as described above with respect FIG. 12. The server 2 transmits a Hello packet in step S552. In step S554, the server 2 receives a Hello packet from the router 10a. The server 2 and router 10a exchange database description packets in steps S556 and S558, and exchange link state information in steps S560-S568. In step S570, the server 2 updates the device search location subnet list. Further, in steps S572-S576, the server 2 performs a search for the monitored devices on each of the subnets 12a-12c, respectively.

FIG. 14 illustrates the device discovery process for devices connected to subnets 10a and 10b in the network 1. In step S602, the server transmits an SNMP request for a device address table from the router 10a. In step S604, the device address table is returned from the router 10a, if available. When the server 2 receives the device address table in step S604, the server 2 requests Management Information Base (MIB) information from each of the printer 6a, the MFP 4a, and the computer 8a in steps S606, S610, and S612, respectively. The server 2 determines whether the devices connected to the subnet 12a are to be monitored based on the returned MIB information.

For example, the server 2 may determine that the device is to be monitored based on whether the MIB information is returned from the device, or information included in the MIB information identifying the device type. In step S608, the printer 6a returns MIB information to the server 2. The MFP 4a returns the MIB information in step S612. However, the computer 8a does not return the MIB information in step S614. Accordingly, in one embodiment of the present invention, the server 2 determines that the printer 6a and MFP 4a are monitored devices on the subnet 12a.

The server 2 performs a device discovery process that is substantially the same as the process performed with respect to steps S602-S616 for each subnet of the network. Accordingly, in step S618, the server 2 transmits a SNMP request for a device address table from the router 10b. In step S620, the device address table is returned to the server 2.

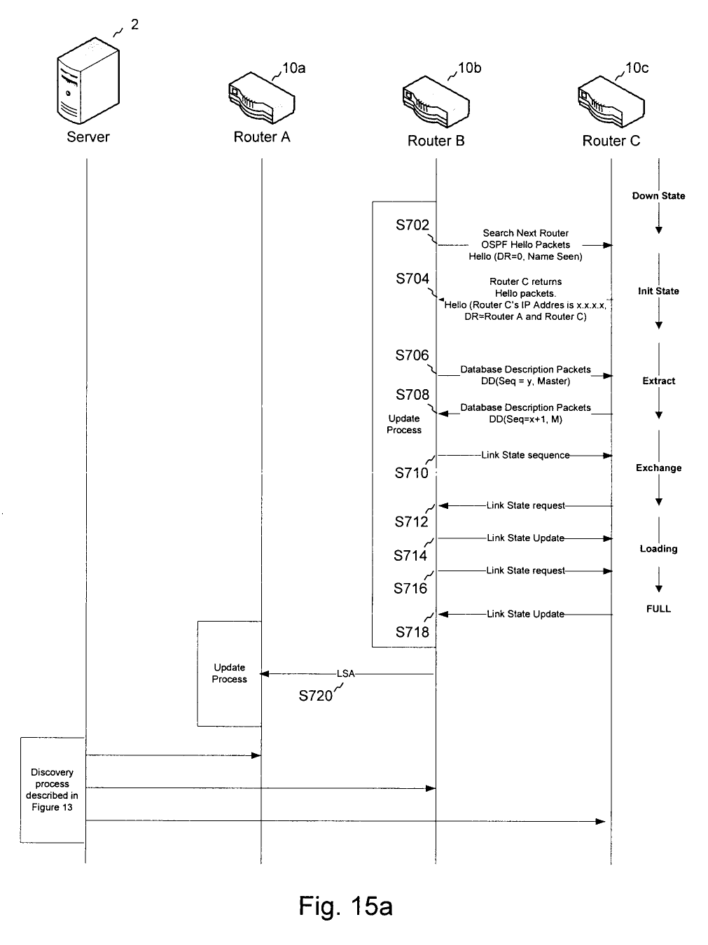

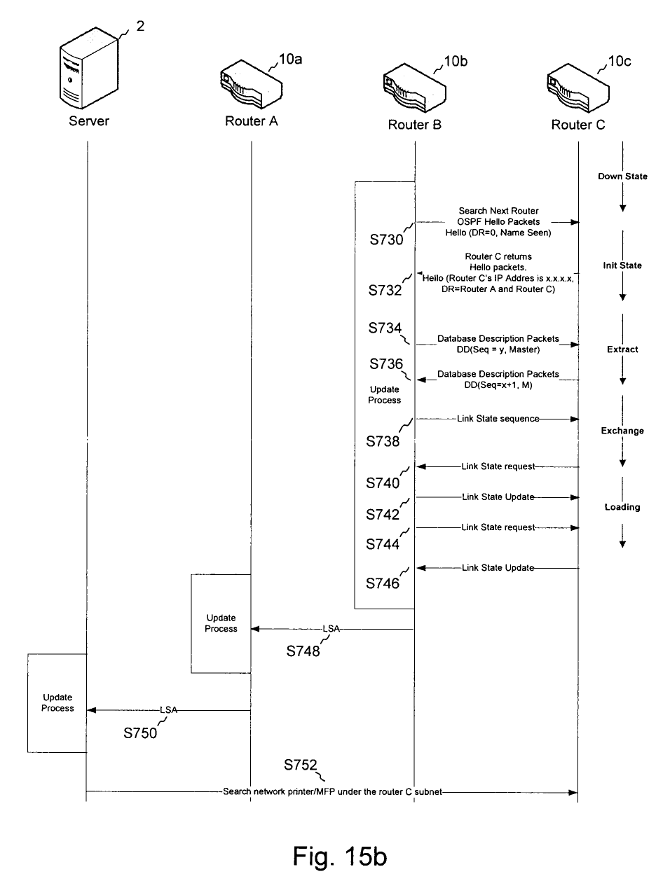

FIGS. 15a and 15b illustrate update processes when the router 10c is added to the network 1. FIG. 15a illustrates an embodiment in which the router 10c is added to the network 1 before the discovery flow process of FIG. 13 has been performed. FIG. 15b illustrates an embodiment in which the router 10c is added to the network 1 after the discovery flow process of FIG. 13 has been performed.

In FIGS. 15a and 15b, steps S702-S718 and S730-S746 are performed in substantially the same manner as steps S502-S518 illustrated in FIG. 12. When the update process is completed in the router 10b, the router 10b transmits a link state advertisement identifying the addition of the router 10c to router 10a in step S720 and S748, respectively.

As illustrated in FIG. 15a, the discovery process of FIG. 13 is performed after the subnet information of router 10c is added to the network database information of the router 10a. Accordingly, the server 2 receives information regarding the router 10c when the discovery process of FIG. 13 is performed. In FIG. 15b, the discovery process of FIG. 13 has already been performed, and thus the server 2 emulates a router on the network 1. In this case, when the router 10a is updated, the router 10a transmits a link state advertisement identifying the addition of the router 10c to the server 2 in step S750. In step S752, the server 2 may perform a search for the monitored device on the subnet corresponding to the router 10c, as discussed above.

Numerous modifications and variations of the present invention are possible in light of the above teachings. It is therefore to be understood that within the scope of the appended claims, the invention may be practiced otherwise than as specifically described herein.

1. A method for detecting a monitored device on one of a plurality of subnets of a network, the method comprising:
receiving, in a processing server, network database information from a local router on a same subnet as the processing server, the network database information identifying the plurality of subnets of the network;
generating a subnet list based on the received network database information;
storing, in a memory, the generated subnet list;
discovering the monitored device based on a search of the plurality of subnets included in the stored subnet list; and
storing an identification of the discovered monitored device in a monitored device database.

2. The method according to claim 1, wherein the discovering step comprises:
determining whether a device address table is available from one of the plurality of subnets, the device address table including an address for each device on the one of the plurality of subnets.

3. The method according to claim 2, wherein the discovering step comprises:
determining, for each address of the device address table, whether the monitored device is associated with the address, when the device address table is available from the one of the plurality of subnets.

4. The method according to claim 3, wherein the discovering step comprises:
determining, for each address of the one of the plurality of subnets, whether the monitored device is associated with the address, when the device address table is unavailable from the one of the plurality of subnets.

5. The method according to claim 1, further comprising:
detecting the local router within the same subnet.

6. The method according to claim 5, wherein the detecting step comprises:
transmitting a hello packet onto the same subnet; and
detecting the local router within the same subnet based on a response to the transmitted hello packet.

7. A processing server configured to connect to a network including a plurality of subnets, comprising:
means for receiving network database information from a local router on a same subnet as the processing server, the network database information identifying the plurality of subnets of the network;
means for generating a subnet list based on the received network database information;
means for storing, in a memory, the generated subnet list;
means for discovering a monitored device based on a search of the plurality of subnets included in the stored subnet list; and
means for storing an identification of the discovered monitored device in a monitored device database.

8. The processing server according to claim 7, wherein the means for discovering determines whether a device address table is available from one of the plurality of subnets, the device address table including an address for each device.

9. The processing server according to claim 8, wherein the means for discovering determines, for each address of the device address table, whether the monitored device is associated with the address, when the device address table is available from the one of the plurality of subnets.

10. The processing server according to claim 9, wherein the means for discovering determines, for each address of the one of the plurality of subnets, whether the monitored device is associated with the address, when the device address table is unavailable from the one of the plurality of subnets.

11. The processing server according to claim 7, further comprising:
means for detecting the local router within the same subnet.

12. The processing server according to claim 11, wherein the means for detecting transmits a hello packet onto the same subnet, and detects the local router within the same subnet based on a response to the transmitted hello packet.

13. A computer-readable storage medium having embedded therein instructions, which when executed by a processor, cause the processor to perform a method of detecting a monitored device on one of a plurality of subnets of a network, the method comprising:
receiving, in a processing server, network database information from a local router on a same subnet as the processing server, the network database information identifying the plurality of subnets of the network;
generating a subnet list based on the received network database information;
storing, in a memory, the generated subnet list;
discovering the monitored device based on a search of the plurality of subnets included in the stored subnet list; and
storing an identification of the discovered monitored device in a monitored device database.

14. A processing server configured to connect to a network including a plurality of subnets, comprising:
a processor including
an acquisition unit configured to receive network database information from a local router on a same subnet as the processing server, the network database information identifying the plurality of subnets of the network;
a subnet list generation unit configured to generate a subnet list based on the received network database information;
a first storage unit configured to store, in a memory, the generated subnet list;
a discovery unit configured to discover a monitored device based on a search of the plurality of subnets included in the stored subnet list; and
a second storage unit configured to store an identification of the discovered monitored device in a monitored device database.
